(19) United States
(12) Patent Application Publication
(10) Pub. No.: US 2013/0338967 A1
(43) Pub. Date: Dec. 19, 2013

(54) SYSTEM FOR CALCULATING AND REPORTING A SCORE

(71) Applicant: Li-San, L'Hay Les Roses (FR)

(72) Inventor: Laurent SANDRIN, L'Hay Les Roses (FR)

(73) Assignee: Li-San, L'Hay Les Roses (FR)

(21) Appl. No.: 13/910,889

(22) Filed: Jun. 5, 2013

(30) Foreign Application Priority Data
Jun. 5, 2012 (FR) 1255197

(51) Int. Cl. G01D 7/00; G01D 7/12

(52) U.S. Cl. CPC G01D 7/00; G01D 7/12; G01D 7/005
USPC 702/189

(57) ABSTRACT

A system for calculating and reporting a drift score, includes a first recording device adapted to record a target value a second recording device adapted to record at least two measured values, each of the measured values being measured at a different time, a calculator adapted to calculate a drift score from a function of the difference between the target value and the at least two measured values as a function of time, a drift indicator adapted to report the drift score calculated from the function.

This application claims the priority of French patent application No. FR1255197, filed on the 5 Jun. 2012, the entire contents of said French patent application being incorporated by reference in the present application.

### TECHNICAL FIELD

An aspect of the invention relates to a system for reporting and calculating a drift score enabling the human brain to become aware of the information transmitted by said score. The system according to the invention finds particularly interesting applications in the fields of health, automobiles and more generally metrology.

### Prior Art

Information is supplied to the human being in a daily manner and some of this information are values that may be for example our body weight, our bank account balance or even the fuel level of our vehicle. All of this everyday information involves a sensor (sight, hearing) that informs our brain of the real value, said brain permanently compares the real value observed with the desired value (the set value) and commands our muscles or our brain (the control organs), to try to bring the real value closer to that which is desired. It should be noted that just the knowledge of this difference between the real value and that which is desired does not allow the human brain to become aware of the effort to supply.

By way of illustration, when a human being weighs himself, he sets himself a target weight that he wishes to attain. However, when he has a real weight close to the target weight, he does not provide the necessary effort to attain his objective such that he does not manage to get rid of the excess kilograms.

### DESCRIPTION OF THE INVENTION

In this context, an aspect of the invention proposes resolving the aforementioned problems. More particularly, an aspect of the invention proposes providing a system for calculating and reporting a drift score enabling the human brain to become aware of the effort to supply to attain an objective.

To this end, one aspect of the invention relates to a system for calculating and reporting a drift score, said system comprising:
first recording means or first recording device adapted to record a target value,
second recording means or second recording device adapted to record at least two values measured at different times,
calculation means or calculator adapted to calculate a drift score from a function, for example of integral type, of the difference between said target value and said at least two measured values as a function of time, (in other words, the function is a temporal function),
a drift indicator adapted to report said drift score calculated from said function.

In a comparative manner to signalling systems of an indicator or score of information of the prior art, the user of the system according to an embodiment of the invention holds an additional information supplied by the signalling of the drift score having a temporal aspect, the temporal aspect enables the human brain to become aware of the drift and to easily integrate the effort to supply to attain his objective.

The system for calculating and reporting a drift score according to an embodiment of the invention can also have one or more of the characteristics below, considered individually or according to all technically possible combinations thereof.

In a non-limiting embodiment, the function used to calculate the drift score is an integral type function.

In a non-limiting embodiment, the time period of the calculation of the function used to calculate the drift score is comprised between 1 second and 10 years and preferentially between 1 minute and 24 months.

In a non-limiting embodiment, the target value and the measured values are representative of a weight, speed, currency, or fuel.

In a non-limiting embodiment, the system according to the invention comprises adjustment means or adjustment device or human machine interface adapted to define the target value.

In a non-limiting embodiment, the system according to the invention comprises transmission means or transmitter adapted to transmit an alert message of SMS or email type when the drift score attains a predetermined triggering threshold.

In a non-limiting embodiment, the reporting of the drift score via the drift indicator is made in graphic form, in figure form or in sound form.

In a non-limiting embodiment, the reporting is made in the form of a traffic light:
a first colour being displayed when the drift score is below a first threshold value over a determined period,
a second colour being displayed when the drift score is above said first threshold value over said determined period, optionally
a third colour being displayed when the drift score is above a second threshold value over the determined period, said second threshold value being above the first threshold value.

In a non-limiting embodiment, the system according to the invention is formed by a mobile terminal, a global positioning system “GPS”, or a scales.

In a non-limiting embodiment, the system according to the invention comprises means for communicating or device for communicating with a remote server.

### BRIEF DESCRIPTION OF DRAWINGS

Other characteristics and benefits of the invention will become clear from the description that is given hereafter, by way of indication and in no way limiting, with reference to the appended drawings, among which:

FIG. 1 illustrates a non-limiting embodiment of a system for reporting and calculating a drift score according to the invention;

FIG. 2 illustrates a function of the difference between a target value and measured values as a function of time, said function being obtained via the system according to the invention.

### DESCRIPTION OF AT LEAST ONE EMBODIMENT OF THE INVENTION

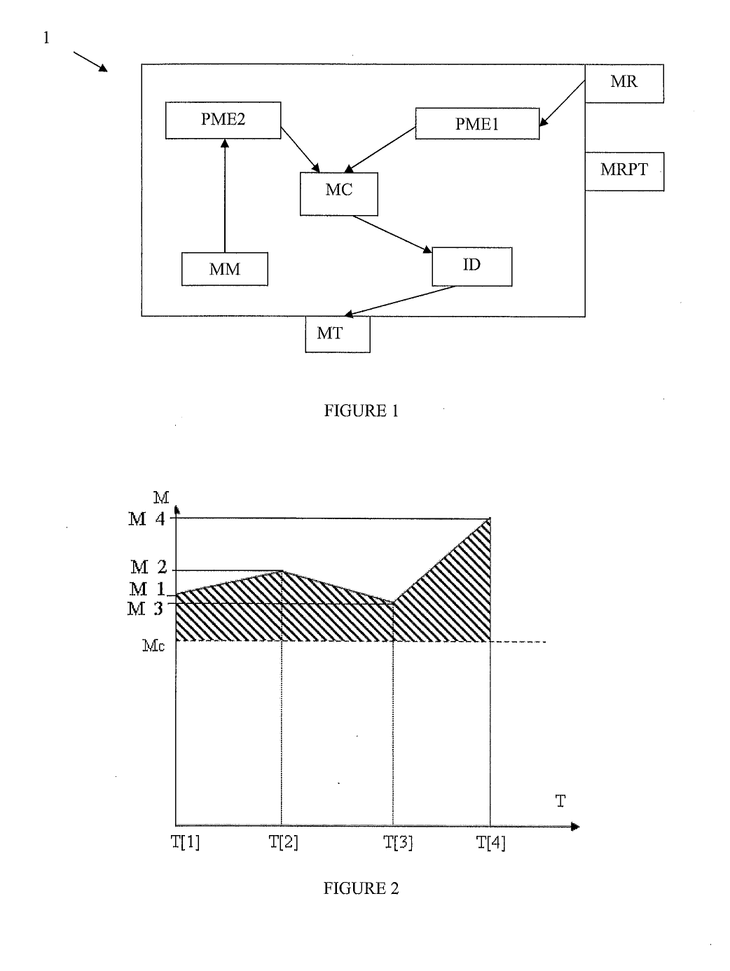

FIG. 1 illustrates an example of non-limiting embodiment of a system 1 for calculating and reporting a drift score. In this example, the application field of the invention is the field of weighing scales.

The system 1 is in this example formed by a scales and comprises in particular:
adjustment means or interface MR adapted to define a target value,
first recording means or first recording device PME1 adapted to record the target value,
measuring means or system MM,
second recording means or second recording device PME2 adapted to record at least two measured values, each of the measured values being measured at a different time,
calculation means or calculator MC adapted to calculate a drift score from a function of the difference between the target value and at least two measured values as a function of time,
a drift indicator ID adapted to report the drift score calculated by means of the function.

The adjustment means or the human machine interface MR may be formed by touch buttons that comprises a screen of a scales. Said buttons enable the user to define a target weight corresponding for example to his body mass index also known under the acronym BMI.

The first recording means or first recording device PME1 make it possible to memorise the target value, his body mass index in the example. The first recording device PME1 may comprise a memory or another device.

The measuring means or system MM may be formed by a weight sensor making it possible to define the weight of a person, the second recording means PME2 making it possible to record the measured weight via the weight sensor. Thus, at each use of the scales by the user his weight measured by the weight sensor MM is recorded by the second recording means or second recording device PME2. The second recording device may comprise a memory or another device.

The calculation means or calculator MC are adapted to calculate a drift score from the function of the difference between the target value and the measured values as a function of time. To this end, the target value and the measured values are transmitted to the calculation means or calculator MC. The calculator may comprise electronic components.

In a non-limiting example illustrated in FIG. 2, this function is an integral type function. This graph illustrates the different weights M measured via the measuring means MM at different times T. The barred area illustrates the integral of the difference between the target weight Mc and the weights M1, M2, M3 and M4 measured at different times, respectively T1, T2, T3 and T4.

Moreover, the drift indicator ID is adapted to report the drift score calculated from said function, said drift score may for example consist of a value representative of the barred area on the graph of FIG. 2. In this case, the drift indicator ID may be formed by a screen able, to display the value and/or a loudspeaker able to indicate the value in an audible manner.

The drift score SD formed by a value may for example be calculated via the following formula:

$$SD = ( T [ 4 ] - T [ 3 ] ) \times \frac{( M [ 4 ] + M [ 3 ] - 2 Mc )}{2} + ( T [ 3 ] - T [ 2 ] ) \times \frac{( M [ 3 ] + M [ 2 ] - 2 MC )}{2} + ( T [ 2 ] - T [ 1 ] ) \times \frac{( M [ 2 ] + M [ 1 ] - 2 MC )}{2}$$

### With:

T(n)=time;
M(n)=measured weight;
Mc=target weight.

A benefit of the invention resides in that the drift score SD is a value representative of the difference between a target value and measured values as a function of time. This particularity enables the human brain to become aware of his drift and thus to integrate more easily the effort to supply to reduce said drift and thus to reach the target value.

It should be noted that the time period of the calculation of the function may be infinite. This time period may also be defined via adjustment means or human machine interface MRPT of the time period. This defined time period may for example be comprised between 1 second and 10 years or preferentially between 1 minute and 24 months.

In a different embodiment, not illustrated, the reporting made by the drift indicator ID is made in the form of a traffic light. This embodiment is based on the use of two threshold values.

In this embodiment, a first colour, for example green, is displayed when the drift score is below a first threshold value over a determined period. This first colour illustrates the fact that over a determined period (for example 6 months) the measured weight of the user corresponds substantially to the target weight. In other words, the drift of the user over a period of 6 months is virtually inexistent.

A second colour, for example orange, is displayed when the drift score is comprised between the first threshold value and a second threshold value over the determined period. This second colour illustrates the fact that over the determined period the measured weight of the user over 6 months is on average a little above the target weight. In other words, the drift of the user is fluctuating, it may be above or below the target weight.

Then, a third colour, for example red, is displayed when the drift score is above the second threshold value over the determined period, the second threshold value being above the first threshold value. This third colour illustrates the fact that, over the determined period, the weight of the user is on average well above the target weight. In other words, the drift of the user is considerable.

Moreover, as illustrated in FIG. 1, the system 1 according to an embodiment of the invention may comprise transmission means or transmitter MT adapted to transmit the drift score to a remote server or to transmit an alert message, for example of SMS or email type when the drift score attains a predetermined triggering threshold. Said triggering threshold can for example correspond to a body mass index leading to a risk of morbidity. The alert message is then transmitted to the attending physician of the user. Thus, the physician can contact the user to define, in the aforementioned example, a nutrition programme.

The invention has been more particularly described in the case of an application to weighing scales. It is understood that the invention is in no way limited to such a use and may be applied for example in the automobile or accounting field.

By way of non-limiting example, the system may for example be formed by:
a mobile terminal, in this case the target and measured values may be representative of the currency of the bank account of the user;
a global positioning system “GPS”, in this case the target and measured values may be a travel speed.

In another example, the target and measured values may be representative of the fuel of the vehicle.

In the case of the automobile field, a vehicle may be equipped with a global positioning system GPS adapted to determine the maximum authorised speed in real time. Said maximum authorised speed may be transmitted from the GPS to the system for calculating and reporting a drift score according to the invention so as to record, via the first recording means or first recording device PME1, this maximum speed. The maximum value thus forms the target value and varies as a function of time. Moreover, the second recording means or second recording device PME2 record the speeds of the vehicle as a function of time, these measured speeds (i.e. measured values) being measured via the measuring means MM, which measuring means MM may be formed by a speed sensor. According to such a use, the system according to the invention enables the user to be informed, via the drift indicator, of his drift compared to the maximum authorised speed. Is it generally rather above or below the maximum authorised speed? This drift score enables the motorist to become aware of the nature of his driving.

Generally speaking, the invention proposed consists in presenting to the user a score of a new type. This score is an integrator of the difference that separates the actual value (measured value) from the measurement of the objective (target value). It thus involves integrating this difference over a certain time and representing it for example in the form of a figure, a graph, a sound or any other signalling means.

1. System for calculating and reporting a drift score, said system comprising:
a first recording device adapted to record a target value,
a second recording device adapted to record at least two measured values, each of the measured values being measured at a different time,
a calculator adapted to calculate a drift score from a function of the difference between said target value and said at least two measured values as a function of time,
a drift indicator adapted to report said drift score calculated from said function.

2. System according to claim 1, wherein the function is an integral type function.

3. System according to claim 1, wherein the time period of the calculation of the function is comprised between 1 second and 10 years.

4. System according to claim 1, wherein the target value and the measured values are representative:
of a weight,
of a speed,
of currency, or
of fuel.

5. System according to claim 1, comprising an adjustment device adapted to define the target value.

6. System according to claim 1, comprising a transmitter adapted to transmit an alert message when the drift score reaches a predetermined triggering threshold.

7. System according to claim 1, wherein the reporting is made in graphic form.

8. System according to claim 1, wherein the reporting is made in figure form.

9. System according to claim 1, wherein the reporting is made in sound form.

10. System according to claim 1, wherein the reporting is made in the form of a traffic light:
a first colour being displayed when the drift score is below a first threshold value over a determined period,
a second colour being displayed when the drift score is above said first threshold value over said determined period.

11. System according to claim 10, wherein a third colour is displayed when the drift score is above a second threshold value over the determined period, said second threshold value being above the first threshold value.

12. System according to claim 1, said system being:
a mobile terminal
a global positioning system “GPS”, or
a scales.

13. System according to claim 1, comprising a device for communicating with a remote server.

14. System according to claim 3, wherein the time period of the calculation of the function is comprised between 1 minute and 24 months.
